(19) United States
(12) Patent Application Publication
(10) Pub. No.: US 2019/0353888 A1
(43) Pub. Date: Nov. 21, 2019

(54) Compact Telescope Design

(71) Applicant: Spectrum Optix Inc., Calgary (CA)

(72) Inventors: Clark Pentico, Simi Valley, CA (US); Brandon DesRoches, Edmonton (CA); Darcy Daugela, Edmonton (CA); Yeefang Xiao, Edmonton (CA)

(21) Appl. No.: 16/415,142

(22) Filed: May 17, 2019

Related U.S. Application Data
(60) Provisional application No. 62/673,033, filed on May 17, 2018.

(51) Int. Cl. G02B 23/02

(52) U.S. Cl. CPC G02B 23/02

(57) ABSTRACT

A folded telescope system providing a light path to an image plane can include a first double-sided corrector plate having two powered sides, with at least one side being aspheric. In addition, the system includes a second double-sided corrector plate having two powered sides and a lens assembly positioned between the first and second double-sided corrector plates to define an image plane also positioned between the first and second double-sided corrector plates. In some embodiments a sensor is positioned at the image plane, with the folded telescope being positioned within or attachable to a display.

### CROSS REFERENCE TO RELATED PATENT APPLICATION

The present application is a continuation of U.S. Patent Application No. 62/673,033, filed on May 17, 2018, which is incorporated by reference in its entirety.

### TECHNICAL FIELD

The present disclosure relates to a compact, high magnification, folded optical telescopic system. In particular, a telescope system is described that provides long range and high-resolution imaging capability and is further able to fit in a thin form factor, including a handheld device.

### BACKGROUND

Long range imaging systems for handheld devices such as scopes and binoculars typically have a long form factor in a direction of an input light path. For high magnification handheld optical systems with long focal lengths, this can result in systems that are long, and bulky, and difficult to carry.

Folding mirrors have been used to change light path direction in order to make the system fit in a particular space, rearranging the optical train without adding any surfaces that have optical power. For example, it is possible to put a folding mirror in front of a telescopic optical system to change the form factor and make it smaller in one dimension. Unfortunately, this will increase the overall system volume, and many such designs are often limited to a very narrow field of view.

### SUMMARY

A folded telescope system providing a light path to an image plane can include a first double-sided corrector plate having two powered sides, with at least one side being aspheric. In addition, the system includes a second double-sided corrector plate having two powered sides and a lens assembly positioned between the first and second double-sided corrector plates to define an image plane also positioned between the first and second double-sided corrector plates. In some embodiments a sensor is positioned at the image plane, with the folded telescope being positioned within or attachable to a display.

Another embodiment of a folded telescope system providing a light path to an image plane includes a first double-sided corrector plate having two powered sides, with at least one side being aspheric and a fold optic having a hole defined therethrough that is positioned to receive light from the first double-sided corrector plate.

In another embodiment a folded telescope system providing a light path to an image plane includes a first double-sided corrector plate having two powered sides, with at least one side being aspheric. The system also includes a spherical reflecting mirror and a second double-sided corrector plate having two powered sides that is positioned in contact or adjacent to the spherical reflecting mirror.

In another embodiment a folded telescope system includes a first double-sided corrector plate having two powered sides, with at least one side being aspheric. A second double-sided corrector plate having two powered sides can also be provided. The system also includes a spherical reflecting mirror and a lens assembly positioned between the first and second double-sided corrector plates to define an image plane also positioned between the first and second double-sided corrector plates.

In another embodiment a folded telescope system includes providing a light path to an image plane includes a first double-sided corrector plate having two powered sides, with at least one side being aspheric and a fold optic having a hole defined therethrough and positioned to receive light from the first double-sided corrector plate. The system also includes a second double-sided corrector plate having two powered sides, a spherical reflecting mirror, and a lens assembly to receive light passing the hole in the fold optic and define an image plane.

In another embodiment a folded telescope system includes providing a light path to an image plane includes a first double-sided corrector plate having two powered sides, with at least one side being aspheric and fold optic having a hole defined therethrough and positioned to receive light from the first double-sided corrector plate. The system also includes a spherical reflecting mirror positioned to direct light the hole defined in the fold optic and a lens assembly positioned to receive light passing the hole in the fold optic and define an image plane positioned substantially parallel to the first double-sided corrector plate.

### BRIEF DESCRIPTION OF THE DRAWINGS

Non-limiting and non-exhaustive embodiments of the present disclosure are described with reference to the following figures, wherein like reference numerals refer to like parts throughout the various figures unless otherwise specified.

FIG. 1 illustrates a folded optical design for a telescope;

FIG. 2 illustrates another folded optical design for a telescope; and

FIG. 3 illustrates a folded optical design for a telescope useful for direct viewing.

### DETAILED DESCRIPTION

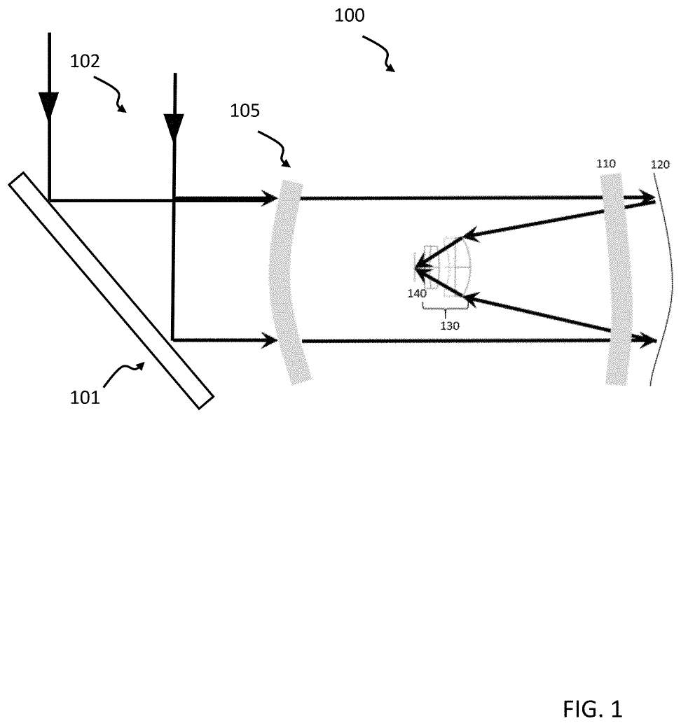

As seen in FIG. 1, a folded optical system 100 with a fold optic 101 defines a light path 102 that passes through a corrector plate 105 which is optically powered on both sides, and travels through an optional second corrector plate 110. The light path then reflects from a reflective surface 120, and returns through optional corrector plate 110, before entering focusing lens group 130, and focusing on an imaging plane 140 that can support imaging using a CCD, CMOS, or other imaging sensor. Since the first corrector plate 105 has power on both surfaces, the total track length of the lens can be reduced. Another aspect of this design is that the second corrector plate 110 is bidirectional, with the light path passing through it twice. This design allows the primary mirror to be spherical, making it lower cost to manufacture. If the second corrector plate 110 is not used, then the primary mirror needs to be aspheric to retain image quality. This design can shorten the total track length while keeping a longer focal length, and system volume, and provide a high quality, near diffraction limited image.

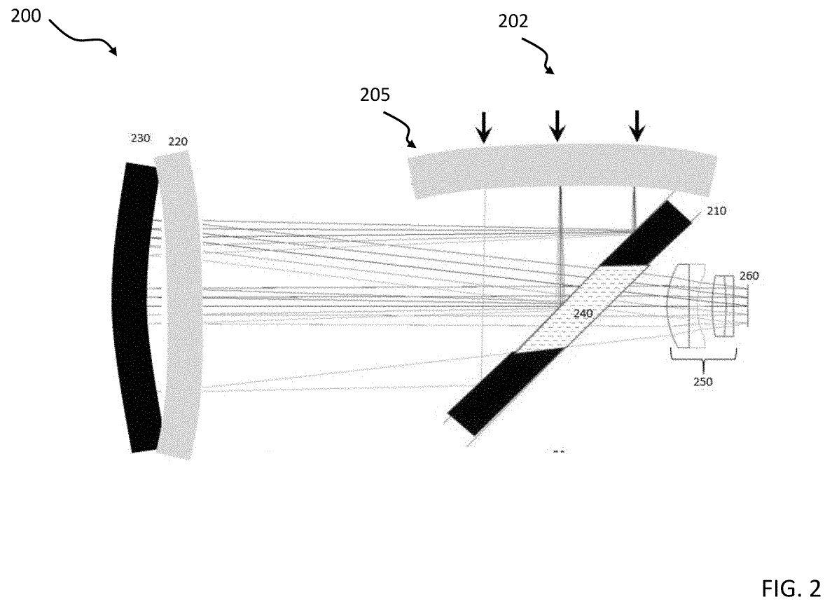

FIG. 2 shows another implementation of a folded optical system 200. The light path 202 hits a corrector plate 205 which is optically powered on both surfaces, reflects off of a folding mirror surface 210, and travels through an optional second corrector plate 220. The light path then reflects off a reflective surface 230, and returns through the optional corrector plate 220, before passing through a hole 240 in the folding mirror 210 before entering focusing lens group 250 and focusing on an imaging plane 260 that can support imaging using a CCD, CMOS, or other imaging sensor. This design can provide a compact lens assembly that has a large aperture in a short depth, making it suitable for thin devices. Advantageously, this form factor is easy to hand-hold as a viewable telescopic scope. Since the first corrector plate 205 has optical power on both sides, the total track length of the lens can be reduced. Additionally, since the second corrector plate is bidirectional because the light passes through it twice, the primary mirror can be spherical, reducing manufacturing cost. If the second corrector plate 220 is not used, then the primary mirror needs to be aspheric to retain image quality. Advantageously, the form factor allows the system to have a large aperture in a thin depth. This design can also shorten the total track length while keeping a longer focal length, reduce overall volume, and provide a high quality, near diffraction limited image

Table 1 below gives a one possible detailed lens and mirror configuration similar to that illustrated with respect to FIG. 2.

TABLE 1

| # | Type | Comment | Radius | Thickness | Material | Semi-Diameter |
|---|---|---|---|---|---|---|
| 2 | STANDARD | Input Aperture/Stop | 1.01E+03 | 6.00E+00 | ACRYLIC | 2.69E+01 |
| 3 | EVENASPH | Corrector Plate Exit | −1.44E+03 | 0.00E+00 | | 2.70E+01 |
| 4 | COORDBRK | | Infinity | 0.00E+00 | | 0.00E+00 |
| 5 | STANDARD | | Infinity | 2.20E+01 | | 2.70E+01 |
| 6 | COORDBRK | | Infinity | 0.00E+00 | | 0.00E+00 |
| 7 | STANDARD | Hole in mirror | Infinity | 0.00E+00 | | 3.81E+01 |
| 8 | STANDARD | Mirror | Infinity | 0.00E+00 | MIRROR | 3.81E+01 |
| 9 | COORDBRK | | Infinity | −6.50E+01 | | 0.00E+00 |
| 10 | STANDARD | Secondary Corrector | −8.57E+02 | −6.50E+00 | ACRYLIC | 3.20E+01 |
| 11 | STANDARD | | −5.39E+02 | −3.50E+00 | | 3.20E+01 |
| 12 | STANDARD | Primary Mirror | 2.18E+02 | 3.50E+00 | MIRROR | 3.10E+01 |
| 13 | STANDARD | Secondary Corrector | −5.39E+02 | 6.50E+00 | ACRYLIC | 3.20E+01 |
| 14 | STANDARD | | −8.57E+02 | 0.50E+01 | | 3.20E+01 |
| 15 | COORDBRK | | Infinity | 0.00E+00 | | 0.00E+00 |
| 16 | STANDARD | Hole Footprint | Infinity | 0.00E+00 | | 2.00E+01 |
| 17 | COORDBRK | | Infinity | 0.00E+00 | | 0.00E+00 |
| 18 | STANDARD | | Infinity | 1.83E+01 | | 1.27E+01 |
| 19 | STANDARD | Focus Doublet 1 | 1.50E+01 | 4.00E+00 | BAK4 | 7.90E+00 |
| 20 | STANDARD | | −7.68E−02 | 1.50E+00 | LAF20 | 7.27E+00 |
| 21 | STANDARD | | 1.36E+01 | 2.72E+00 | | 6.25E+00 |
| 22 | STANDARD | Focus Doublet 2 | 2.24E+01 | 2.50E+00 | SK5 | 5.85E+00 |
| 23 | STANDARD | | −4.10E+01 | 1.40E+00 | F7 | 5.52E+00 |
| 24 | STANDARD | | −3.23E+02 | 3.55E+00 | | 5.16E+00 |
| 25 | STANDARD | Detector Surface | Infinity | 0.00E+00 | | 3.84E+00 |

| # | Mech Semi-Dia | Conic | Term | Term | Term | Term |
|---|---|---|---|---|---|---|
| 2 | 2.69E+01 | 0.00E+00 | 0.00E+00 | 0.00E+00 | 0.00E+00 | 0.00E+00 |
| 3 | 2.70E+01 | 0.00E+00 | 0.00E+00 | 8.32E−08 | −4.64E−13 | 0.00E+00 |
| 4 | 0.00E+00 | 0.00E+00 | 0.00E+00 | 0.00E+00 | 0.00E+00 | 0.00E+00 |
| 5 | 2.70E+01 | 0.00E+00 | 0.00E+00 | 0.00E+00 | 0.00E+00 | 0.00E+00 |
| 6 | 0.00E+00 | 0.00E+00 | 0.00E+00 | 0.00E+00 | 4.50E+01 | 0.00E+00 |
| 7 | 3.81E+01 | 0.00E+00 | 0.00E+00 | 0.00E+00 | 0.00E+00 | 0.00E+00 |
| 8 | 3.81E+01 | 0.00E+00 | 0.00E+00 | 0.00E+00 | 0.00E+00 | 0.00E+00 |
| 9 | 0.00E+00 | 0.00E+00 | 0.00E+00 | 0.00E+00 | 4.50E+01 | 0.00E+00 |
| 10 | 3.20E+01 | 0.00E+00 | 0.00E+00 | 0.00E+00 | 0.00E+00 | 0.00E+00 |
| 11 | 3.20E+01 | −6.81E+01 | 0.00E+00 | 0.00E+00 | 0.00E+00 | 0.00E+00 |
| 12 | 3.10E+01 | 0.00E+00 | 0.00E+00 | 0.00E+00 | 0.00E+00 | 0.00E+00 |
| 13 | 3.20E+01 | −6.81E+01 | 0.00E+00 | 0.00E+00 | 0.00E+00 | 0.00E+00 |
| 14 | 3.20E+01 | 0.00E+00 | 0.00E+00 | 0.00E+00 | 0.00E+00 | 0.00E+00 |
| 15 | 0.00E+00 | 0.00E+00 | 0.00E+00 | 0.00E+00 | −4.50E+01 | 0.00E+00 |
| 16 | 2.00E+01 | 0.00E+00 | 0.00E+00 | 0.00E+00 | 0.00E+00 | 0.00E+00 |
| 17 | 0.00E+00 | 0.00E+00 | 0.00E+00 | 0.00E+00 | 4.50E+01 | 0.00E+00 |
| 18 | 1.27E+01 | 0.00E+00 | 0.00E+00 | 0.00E+00 | 0.00E+00 | 0.00E+00 |
| 19 | 7.90E+00 | 0.00E+00 | 0.00E+00 | 0.00E+00 | 0.00E+00 | 0.00E+00 |
| 20 | 7.90E+00 | 0.00E+00 | 0.00E+00 | 0.00E+00 | 0.00E+00 | 0.00E+00 |
| 21 | 7.90E+00 | 0.00E+00 | 0.00E+00 | 0.00E+00 | 0.00E+00 | 0.00E+00 |
| 22 | 5.85E+00 | 0.00E+00 | 0.00E+00 | 0.00E+00 | 0.00E+00 | 0.00E+00 |
| 23 | 5.85E+00 | 0.00E+00 | 0.00E+00 | 0.00E+00 | 0.00E+00 | 0.00E+00 |
| 24 | 5.85E+00 | 0.00E+00 | 0.00E+00 | 0.00E+00 | 0.00E+00 | 0.00E+00 |
| 25 | 3.84E+00 | 0.00E+00 | 0.00E+00 | 0.00E+00 | 0.00E+00 | 0.00E+00 |

Lens and mirror configuration of another embodiment are described in the below Table 2:

TABLE 2

| | Type | Comment | Radius | Thickness | Material | Semi-Dia [symbol] |
|---|---|---|---|---|---|---|
| 0 | STANDARD | | Infinity | 1.00E+10 | | 0.00E+00 |
| 1 | STANDARD | | Infinity | 2.00E+01 | | 2.77E+01 |
| 2 | STANDARD | | Infinity | 0.00E+00 | | 2.69E+01 |
| 3 | STANDARD | Outer lens Surafce | −3.02E+02 | 6.00E+00 | E48R | 2.70E+01 |
| 4 | EVENASPH | | −3.60E+02 | 0.00E+00 | | 2.72E+01 |
| 5 | COORDBRK | | Infinity | 0.00E+00 | | 0.00E+00 |
| 6 | STANDARD | | Infinity | 2.40E+01 | | 2.72E+01 |
| 7 | COORDBRK | | Infinity | 0.00E+00 | | 0.00E+00 |
| 8 | STANDARD | Hole in mirror | Infinity | 0.00E+00 | | 3.92E+01 |
| 9 | STANDARD | Mirror | Infinity | 0.00E+00 | MIRROR | 3.98E+01 |
| 10 | COORDBRK | | Infinity | −7.00E+01 | | 0.00E+00 |
| 11 | STANDARD | Corrector | −6.32E+02 | −6.50E+00 | E48R | 3.20E+01 |
| 12 | STANDARD | | −1.00E+03 | −2.25E+00 | | 3.20E+01 |
| 13 | STANDARD | Primary | 2.34E+02 | 2.25E+00 | MIRROR | 3.10E+01 |
| 14 | STANDARD | Corrector | −1.00E+03 | 6.50E+00 | E48R | 3.20E+01 |
| 15 | STANDARD | | −6.32E+02 | 7.00E+01 | | 3.20E+01 |
| 16 | COORDBRK | | Infinity | 0.00E+00 | | 0.00E+00 |
| 17 | STANDARD | Hole Footprint | Infinity | 0.00E+00 | | 2.19E+01 |
| 18 | COORDBRK | | Infinity | 0.00E+00 | | 0.00E+00 |
| 19 | STANDARD | | Infinity | 2.12E+01 | | 1.36E+01 |
| 20 | STANDARD | | 1.50E+01 | 5.00E+00 | N-BK7 | 9.00E+00 |
| 21 | STANDARD | | −7.50E+01 | 1.50E+00 | N-LAF21 | 9.00E+00 |
| 22 | STANDARD | | 1.50E+01 | 2.30E+00 | | 7.50E+00 |
| 23 | STANDARD | | 4.19E+01 | 3.00E+00 | N-BK7 | 7.00E+00 |
| 24 | STANDARD | | −4.19E+01 | 3.49E+00 | | 7.00E+00 |
| 25 | STANDARD | Sensor Cover Glass | Infinity | 5.00E−01 | N-BK7 | 7.00E+00 |
| 26 | STANDARD | | Infinity | 0.00E+00 | | 3.84E+00 |

[symbol]

indicates data missing or illegible when filed

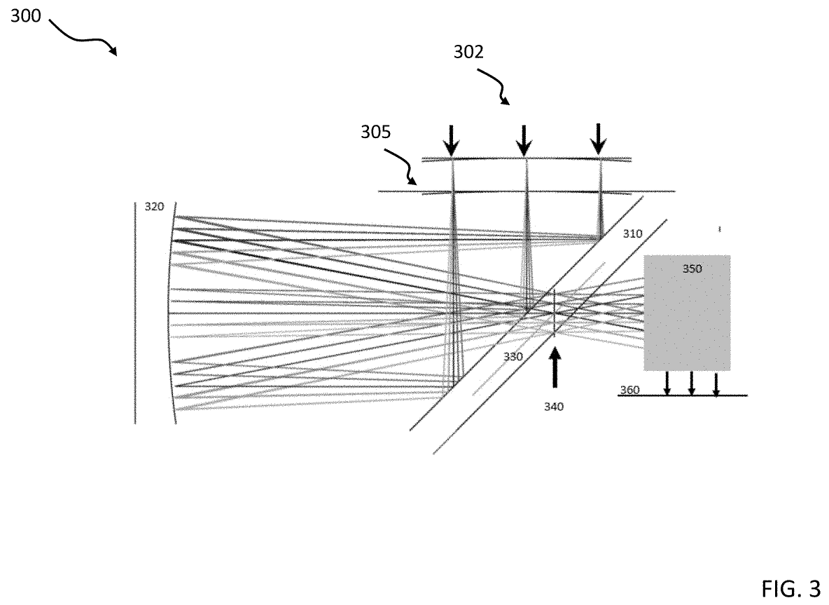

FIG. 3 shows another example of a folded telescope system 300. The light path 302 enters the system, travels through a corrector plate 305 which is optically powered on both surfaces, reflects off a folding mirror surface 310, and travels through an optional second corrector plate (not shown). The light path then reflects off a reflective surface 320 and returns through the optional corrector plate (not shown), before passing through a hole 340 in the folding mirror 310 before entering focusing lens group 350 and focusing on an imaging plane 360 that can support imaging using a CCD, CMOS, or other imaging sensor. As compared to the embodiment illustrated with respect to FIG. 2, in this embodiment the image plane is focused near the hole 340. This allows the hole size to be reduced in diameter, which assists in retaining the light intensity and high contrast in the mid frequency range. Another feature shown in this embodiment is that the lens group 350 focuses and folds the light path again. This allows the image plane to be in the same orientation as the entering light, which may be helpful for analog (non-digital) direct view devices. In some embodiments, eyepieces or image relay optics can also be used in the system.

Compact and lightweight telescope designs such as described above can be used in various applications that require high magnification and high-quality images. For example, such telescopes can be used in handheld devices like cameras or mobile smartphones, drones or remote operated vehicles, fixed or handheld telescopes for consumer, security, or military use, vehicle use in general, or machine vision applications that benefit from high resolution and a relatively narrow field of view. In certain embodiments, the telescope can be associated with a display system that is attached or near the telescope assembly. Alternatively, using wired or wireless connections to an imaging sensor for the telescope assembly, a separate display can be available for remote viewing.

As will be appreciated, folding the optics using powered prisms allows for a substantial reduction in necessary depth of the folded telescope system and its associated mount or case, along with providing an increase in focal length and ability to support large lens apertures and image sensors. Lens systems can include either/both glass or plastic lens elements, or reflective optically powered mirrors. Symmetrical, aspheric, flat, or graded index lenses can be used, as well as advanced metamaterial/nanomaterial lenses. In some embodiments rectangular or “trimmed” rectangular lens (i.e. circular lens with top and bottom having flat sides, while left and right sides remain curved) can be used. Use of rectangular lens systems allow more light to be captured in a compact space, and to maximize the effective resolution for a given volume. In some embodiments, optics and sensors can be arranged to allow viewing in non-visible spectrums such as near infrared, or infrared, or ultraviolet. For example, sensors having pixels sensitive to infrared or ultraviolet wavelengths can be used. In some embodiments, use of additional filters or optics with reduced ultraviolet absorption may be required.

Non-limiting and non-exhaustive embodiments of the present disclosure are described with reference to the following figures, wherein like reference numerals refer to like parts throughout the various figures unless otherwise specified.

Reference throughout this specification to “one embodiment,” “an embodiment,” “one example,” or “an example” means that a particular feature, structure, or characteristic described in connection with the embodiment or example is included in at least one embodiment of the present disclosure. Thus, appearances of the phrases “in one embodiment,” “in an embodiment,” “one example,” or “an example” in various places throughout this specification are not necessarily all referring to the same embodiment or example. Furthermore, the particular features, structures, databases, or characteristics may be combined in any suitable combinations and/or sub-combinations in one or more embodiments or examples. In addition, it should be appreciated that the figures provided herewith are for explanation purposes to persons ordinarily skilled in the art and that the drawings are not necessarily drawn to scale.

1. A folded telescope system providing a light path to an image plane, comprising:
a first double-sided corrector plate having two powered sides, with at least one side being aspheric;
a second double-sided corrector plate having two powered sides; and
a lens assembly positioned between the first and second double-sided corrector plates to define an image plane positioned between the first and second double-sided corrector plates.

2. The folded telescope system of claim 1, further comprising an image sensor positioned at the image plane, the folded telescope being positioned within or attachable to a display.

3. A folded telescope system providing a light path to an image plane, comprising:
a first double-sided corrector plate having two powered sides, with at least one side being aspheric; and
a fold optic having a hole defined therethrough and positioned to receive light from the first double-sided corrector plate.

4. The folded telescope system of claim 3, further comprising an image sensor positioned at the image plane, the folded telescope being positioned within or attachable to display.

5. A folded telescope system providing a light path to an image plane, comprising:
a first double-sided corrector plate having two powered sides, with at least one side being aspheric;
a spherical reflecting mirror; and
a second double-sided corrector plate having two powered sides and positioned in contact or adjacent to the spherical reflecting mirror.

6. The folded telescope system of claim 5, further comprising an image sensor positioned at the image plane, the folded telescope being positioned within or attachable to display.

7. A folded telescope system providing a light path to an image plane, comprising:
a first double-sided corrector plate having two powered sides, with at least one side being aspheric;
a second double-sided corrector plate having two powered sides;
a spherical reflecting mirror; and
a lens assembly positioned between the first and second double-sided corrector plates to define an image plane also positioned between the first and second double-sided corrector plates.

8. A folded telescope system providing a light path to an image plane, comprising:
a first double-sided corrector plate having two powered sides, with at least one side being aspheric;
a fold optic having a hole defined therethrough and positioned to receive light from the first double-sided corrector plate;
a second double-sided corrector plate having two powered sides;
a spherical reflecting mirror; and
a lens assembly to receive light passing the hole in the fold optic and define an image plane.

9. The folded telescope system of claim 8, wherein the spherical reflecting mirror is positioned to direct light through the hole defined in the fold optic and the lens assembly is positioned to receive light passing the hole in the fold optic and define the image plane to be positioned substantially parallel to the first double-sided corrector plate.
